(19) United States
(12) Patent Application Publication
(10) Pub. No.: US 2006/0259215 A1
(43) Pub. Date: Nov. 16, 2006

(54) Tire parameter sensing system having a tunable circuit

(75) Inventor: Xing Ping Lin, Orchard Lake, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignees: TRW Automotive U.S. LLC; Societe de Technologie MICHELIN

(21) Appl. No.: 11/128,865

(22) Filed: May 13, 2005

(51) Int. Cl. G06F 19/00

(52) U.S. Cl. 701/29; 340/442

(57) ABSTRACT

A tire parameter sensing system (10) for a vehicle (12) includes a vehicle-based unit (54) for transmitting first signals and for receiving second signals. A tire-based unit (34) is associated with a tire (16) of the vehicle (12). The tire-based unit (34) is responsive to received first signals for sensing a parameter of the tire (16) and for transmitting second signals indicative of the sensed parameter. An antenna portion (144) of the tire-based unit (34) has an impedance that varies in response to varying environmental conditions. The vehicle-based unit (54) including a tuner (106) and a controller (90). The controller (90) monitors a condition of received second signals at various settings of the tuner (106) and thereafter, sets the tuner (106) for maximizing the condition of the received second signals.

### TECHNICAL FIELD

The present invention relates to a tire parameter sensing system for a vehicle and to an associated method. More particularly, the present invention relates to a tire parameter sensing system in which a vehicle-based unit includes a tunable circuit and to an associated method.

### BACKGROUND OF THE INVENTION

Tire parameter sensing systems for vehicles typically include multiple tire-based units and a single vehicle-based unit. Each tire-based unit has an associated tire of the vehicle and is operative to sense at least one parameter of the tire. The sensed parameter(s) may include temperature, pressure, etc. Each tire-based unit is also operative to transmit a parameter signal indicative of the sensed parameter(s) to the vehicle-based unit. The vehicle-based unit is connected to a display. In response to receiving a parameter signal from a tire-based unit, the vehicle-based unit outputs a signal to the display. The display is responsive to the signal for displaying the sensed tire parameter(s).

It is common for the tire-based units of a tire parameter sensing system to be battery powered. Battery powered tire-based units, however, have specific limitations, for example, a limited life, a limited current supply, and a limited operating temperature range. The design of a tire parameter sensing system using battery powered tire-based units must be mindful of these limitations. As a result, it is common for a battery powered tire-based unit to transmit parameter signals only in response to a determination that a sensed parameter is outside of a desired range. For example, if the desired pressure range is 32 to 36 pounds per square inch (“psi”), the battery powered tire-based unit may transmit a parameter signal to the vehicle-based unit only when the sensed tire pressure is determined to be below 32 psi or above 36 psi. By limiting the transmissions of the parameter signal, the battery life of the battery powered tire-based unit may be extended.

In some tire parameter sensing systems, the tire-based units do not include batteries. Tire-based units that do not include batteries commonly receive energy through induction. Power transmitting devices are located adjacent the tires having the tire-based units. The tire-based units include antenna portions that are designed receive energy from the power transmitting devices. Environmental changes, such as changes in temperature, may alter the impedance of the antenna portions of the tire-based units. Since the temperatures within a vehicle tire vary dramatically, tire-based units are extremely susceptible to changes of impedance. A change of impedance may adversely affect the transfer of power to the tire-based unit.

Performance of a tire parameter sensing system in which power is transferred to the tire-based units is optimized when the impedance of each power transmitting device matches the impedance of the antenna portion of its associated tire-based unit. A tire parameter sensing system for matching the impedance of the power transmitting device and the antenna portion of its associated tire-based unit is desirable.

### SUMMARY OF THE INVENTION

The present invention relates to a tire parameter sensing system for sensing a parameter of a tire of a vehicle. The tire parameter sensing system comprises a vehicle-based unit for transmitting first signals and for receiving second signals. A tire-based unit is associated with the tire of the vehicle. The tire-based unit is responsive to received first signals for sensing the parameter of the tire and for transmitting second signals indicative of the sensed parameter. An antenna portion of the tire-based unit has an impedance that varies in response to varying environmental conditions. The vehicle-based unit includes a tuner and a controller. The controller monitors a condition of received second signals at various settings of the tuner and thereafter, sets the tuner for maximizing the condition of the received second signals.

In accordance with another aspect, the present invention relates to a method of operating a tire parameter sensing system of a vehicle. The tire parameter sensing system has a vehicle-based unit and a tire-based unit. The tire-based unit is associated with a tire of the vehicle and includes an antenna portion having an impedance that varies in response to varying environmental conditions. The method comprises the steps of: transmitting first signals from the vehicle-based unit; sensing the parameter of the tire and transmitting second signals in responds to receiving first signals at the tire-based unit; receiving the transmitted second signals at the vehicle-based unit; monitoring a condition of second signals received at the vehicle-based unit at various settings of a tuner of the vehicle-based unit; and thereafter, setting the tuner of the vehicle-based unit for maximizing the condition of the received second signals.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 schematically illustrates a vehicle including a tire parameter sensing system constructed in accordance with an exemplary embodiment of the present invention;

FIG. 2 schematically illustrates a reader portion of a vehicle-based unit of the tire parameter sensing system of FIG. 1;

FIG. 3 schematically illustrates a tire-based unit of the of the tire parameter sensing system of FIG. 1;

FIGS. 4A-4C are graphs in which the power of signals received at the reader portion is plotted as a function of frequency for various tuner settings of a tuning circuit; and

FIG. 5 is a flow diagram illustrating an exemplary process performed by a vehicle-based unit of the tire parameter sensing system of the present invention.

### DETAILED DESCRIPTION OF THE INVENTION

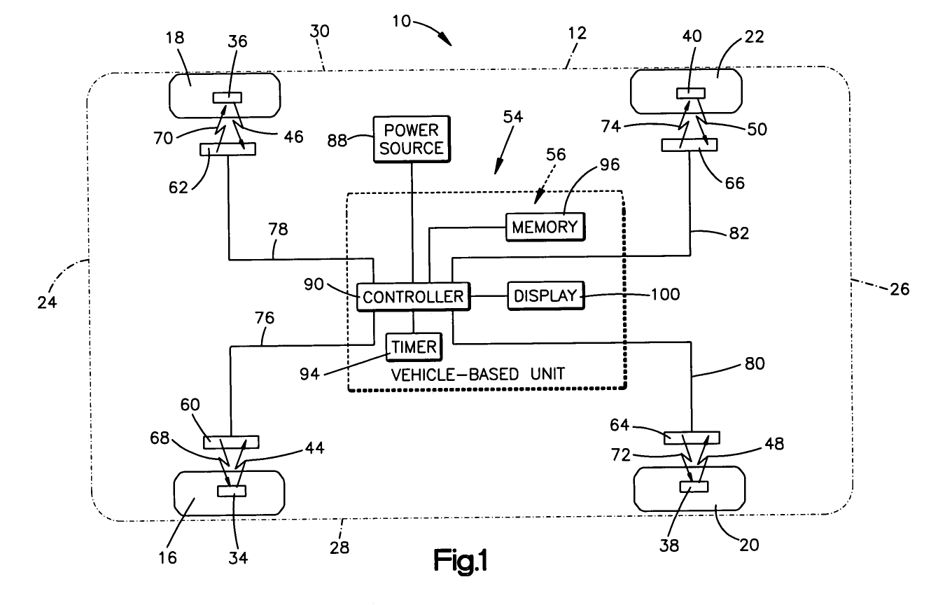

FIG. 1 schematically illustrates a tire parameter sensing system 10 constructed in accordance with the present invention. The tire parameter sensing system is associated with a vehicle 12. For illustrative purposes, the vehicle 12 of FIG. 1 is an automobile having four tires 16, 18, 20, and 22. The tire parameter sensing system 10 of the present invention can be used with vehicles having a number of tires other than four.

The vehicle 12 of FIG. 1 has a front 24, a rear 26, and opposite left and right sides 28 and 30, respectively. FIG. 1 illustrates tire 16 at a front left corner location of the vehicle 12. Tire 18 is located at a front right corner location of the vehicle 12. Tire 20 is located at a rear left corner location of the vehicle 12 and tire 22 is located at a rear right corner location of the vehicle 12.

The tire parameter sensing system 10 includes four tire-based units 34, 36, 38, and 40. Each tire 16,18, 20, and 22 of the vehicle 10 includes an associated tire-based unit 34, 36, 38, and 40, respectively, for sensing at least one parameter, e.g., pressure, temperature, etc., of the tire and for transmitting parameter signals 44, 46, 48, and 50, respectively. The parameter signals 44, 46, 48, and 50 are indicative of the sensed parameter(s) of the tires 16,18, 20, and 22, respectively.

The tire parameter sensing system 10 also includes a vehicle-based unit 54. The vehicle-based unit 54 includes a central portion 56 and four reader portions 60, 62, 64, and 66. One of the reader portions 60, 62, 64, and 66 of the vehicle-based unit 54 is associated with each one of the tire locations of the vehicle 12. Preferably, each reader portion 60, 62, 64, and 66 is located in the wheel well at its associated tire location. Each reader portions 60, 62, 64, and 66 of the vehicle-based unit 54 is also associated with the tire-based unit 34, 36, 38, and 40 of the tire 16,18, 20, and 22, respectively, located in its associated tire location. With reference to FIG. 1, reader portion 60 is associated with tire-based unit 34 of tire 16. Reader portion 62 is associated with tire-based unit 36 of tire 18. Reader portion 64 is associated with tire-based unit 38 of tire 20 and, reader portion 66 is associated with tire-based unit 40 of tire 22. Each reader portion 60, 62, 64, and 66 is configured for transferring power signals 68, 70, 72, and 74 to the tire-based unit 16, 18, 20, or 22 to which it is associated and for receiving parameter signals 44, 46, 48, or 50 transmitted by the tire-based unit 16, 18, 20, or 22.

Each reader portion 60, 62, 64, and 66 of the vehicle-based unit 54 is coupled to the central portion 56 of the vehicle-based unit. FIG. 1 schematically illustrates lines connecting the reader portions 60, 62, 64, and 66 to the central portion 56. In FIG. 1, lines 76 connects reader portion 60 to the central portion 56. Line 78 connects reader portion 62 to the central portion 56. Line 80 connects reader portion 64 to the central portion 56 and, line 82 connects reader portion 66 to the central portion 56. Although not illustrate, each of lines 76, 78, 80, and 82 is formed from multiple wires. The lines 76, 78, 80, and 82 provide signal communication between the central portion 56 and each reader portion 60, 62, 64, and 66 of the vehicle-based unit 54.

As shown in FIG. 1, the central portion 56 of the vehicle-based unit 54 of the tire parameter sensing system 12 receives electrical power from a power source 88. The power source 88 preferably includes the battery of the vehicle 12 and an appropriate voltage regulator (not shown). The central portion 56 of the vehicle-based unit 54 includes a controller 90. The controller 90 is preferably a microcomputer. Alternatively, the controller 90 may be formed from discrete circuitry, an application-specific-integrated-circuit (“ASIC”), or any other type of control circuitry. As an alternative to the central portion 56 including a controller 90, each reader portion 60, 62, 64, and 66 of the vehicle-based unit 54 may include a dedicated controller. A timer 94 is operatively connected to the controller 90. Alternatively, the controller 90 may include an internal timer.

A memory 96 also is operatively connected to the controller 90. Alternatively, the memory 94 may form a portion of the controller 90. The memory 96 is a non-volatile memory that includes a lookup table for associating each reader portion 60, 62, 64, and 66 to its associated tire location on the vehicle 12. The memory 96 also stores a tire parameter sensing algorithm that is performed by the controller 90 of the vehicle-based unit 54.

A display 100 is operatively connected to the controller 90. The display 100 is located in the occupant compartment of the vehicle 12 and is responsive to receipt of display signals from the controller 90 for providing an operator of the vehicle with indications of the sensed tire parameter(s) and, optionally, the associated tire locations. For example, the display 100 may provide visual and/or audio indications of the sensed tire temperatures and the sensed tire pressures for each of the tires 16,18, 20, and 22 of the vehicle 12.

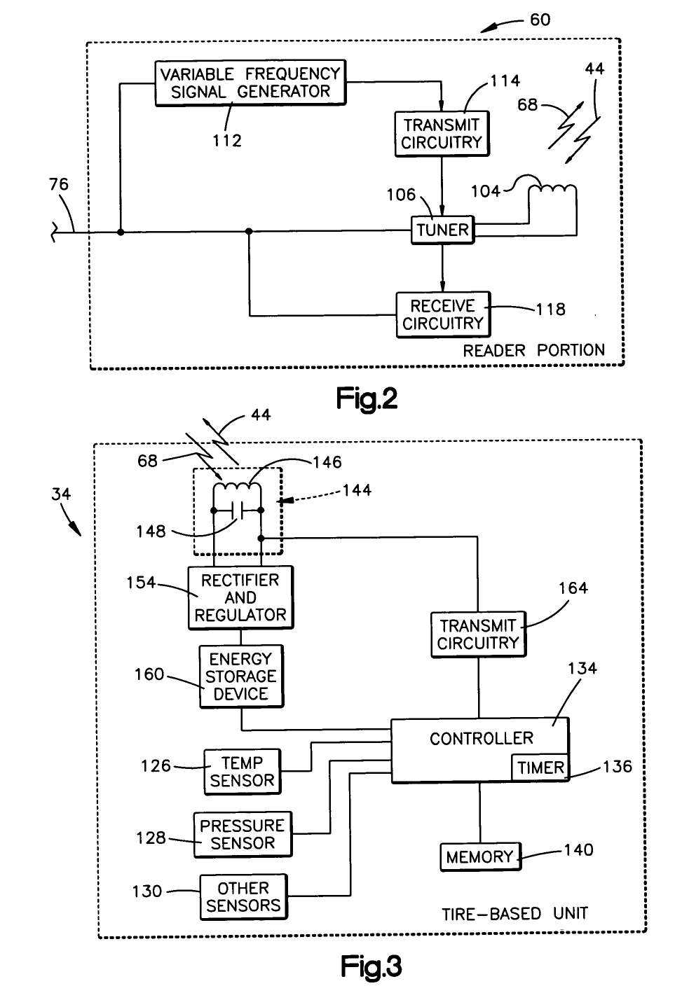

FIG. 2 schematically illustrates reader portion 60 of the vehicle-based unit 54. Reader portions 62, 64, and 66 may have structures similar to reader portion 60 and may operate in a manner similar to reader portion 60. As is shown in FIG. 2, the reader portion 60 includes an antenna 104 and an associated tuner 106 (or tunable circuit). The antenna 104 is a coil antenna that is adapted to become either magnetically or electrically coupled with the tire-based unit 34 located proximate the reader portion 60. The antenna 104 is configured for transmitting power signals 68 and for receiving parameter signals 44.

The tuner 106 is configured for adjusting the impedance of the antenna 104. The tuner 106 may include a bank of capacitors with a switching circuit that enables various combinations of the capacitors to be connected together. Alternatively, the tuner 106 may include a varactor. As can be seen with reference to FIGS. 1 and 2, the tuner 106 is coupled to the controller 90 of the vehicle-based unit 54. The controller 90 controls the tuner 106 for adjusting the impedance of the antenna 104.

As shown in FIG. 2, the reader portion 60 also includes a variable frequency signal generator 112. The variable frequency signal generator 112 may include, for example, an oscillator for providing signals of a predetermined frequency and a digital divider that receives the predetermined frequency and is controllable for outputting signals within a range of frequencies. Other known types of variable frequency signal generators may be used with the present invention. In one example, the variable frequency signal generator 112 is capable of providing signals with frequencies in the range of 900 to 925 MHz.

The variable frequency signal generator 112 is coupled to the controller 90 of the central portion 56 of the vehicle-based unit 54. The controller 90 controls the variable frequency signal generator 112. For example, the controller 90 may determine that the variable frequency signal generator 112 should provide a 915 MHz signal. The controller 90 then controls the variable frequency signal generator 112 for providing a 915 MHz signal.

The variable frequency signal generator 112 provides signals to transmit circuitry 114 of the reader portion 60. The transmit circuitry 114 includes components such as amplifiers and filters for conditioning the signals provided by the variable frequency signal generator 112. The transmit circuitry 114 is coupled to the tuner 106 and provides the conditioned signals to the tuner 106. The tuner 106 provides the signals to the antenna 104 for transmission as power signals 68.

The reader portion 60 also includes receive circuitry 118. The receive circuitry is coupled to the tuner 106. Parameter signals 44 received by the antenna 104 are provided to the receive circuitry 118. The receive circuitry 118 includes a demodulator (not shown) for demodulating the received parameter signals 44 and for outputting message packets received in the parameter signals to the controller 90 of the central portion 56 of the vehicle-based unit 54. Each message packet includes the sensed tire parameter(s). The receive circuitry 118 may also include signal conditioning components such as filters and amplifiers.

As an alternative to each reader portion 60, 62, 64, and 66 including receive circuitry 118, the central portion 56 of the vehicle-based unit 54 may include receive circuitry for demodulating signals from each of the reader portions 60, 62, 64, and 66. When the central portion 56 of the vehicle-based unit 54 includes the receive circuitry for demodulating received parameter signals 44, 46, 48, and 50, each reader portion 60, 62, 64, and 66 may include signal conditioning circuitry for filtering and amplifying the parameter signals being provided to the central portion 56.

FIG. 3 schematically illustrates the tire-based unit 34 of the tire parameter sensing system 10 of FIG. 1. Tire-based units 36, 38, and 40 may have structures similar to tire-based unit 34 and may operate in a manner similar to tire-based unit 34. The tire-based unit 34 includes a one or more sensors operable for sensing one or more parameters of the tire 16. The tire-based unit 34 illustrated in FIG. 3 includes a temperature sensor 126, a pressure sensor 128, and other sensors 130. The temperature sensor 126 is operable for sensing the temperature within the associated tire 16 and for providing temperature signals. The pressure sensor 128 is operable for sensing the pressure within the associated tire 16 and for providing pressure signals. The other sensors 130 are operable for sensing other parameters of either the associated tire 16 or the tire-based unit 34 and for providing other parameter signals indicative of the sensed other parameters. For example, the other sensors 130 may include a voltage sensor for determining a supply voltage within the tire-based unit 34.

The tire-based unit 34 also includes a controller 134. The controller 134 is preferably a microcomputer. Alternatively, the controller 134 may be formed from discrete circuitry, an application-specific-integrated-circuit (“ASIC”), or any other type of control circuitry. The controller 134 is operatively coupled to the temperature sensor 126, the pressure sensor 128, and the other sensors 130 and receives the temperature signals, pressure signals, and other parameter signals, respectively. The controller 134 performs a tire parameter sensing algorithm and outputs a message packet that includes the sensed parameters of the tire 16. As shown schematically in FIG. 3, the controller 134 includes an internal timer 136.

A memory 140 is operatively coupled to the controller 134. Alternatively, the memory 140 may form a portion of the controller 134. The memory 140 is a non-volatile memory in which the tire parameter sensing algorithm for the tire-based unit 34 is stored.

The tire-based unit 34 also includes an antenna portion 144. The antenna portion 144 is a tank circuit that includes a coil antenna 146 and a capacitor 148. The antenna portion 144 has a resonant frequency that is determined by the formula:

$$f = \frac{1}{2 π \sqrt{LC}}$$

in which, f is the resonant frequency of the antenna portion 144, L is the equivalent inductance of the antenna portion, and C is the capacitance of the antenna portion. The antenna portion 144 also has an impedance that is subject to change in response to environmental changes, such as changes in temperature.

The antenna portion 144 is operable to receive electrical energy from the power signals 68 transmitted from the reader portion 60. The power transferred from the reader portion 60 to the tire-based unit 34 is maximized when the power signals 68 have a frequency that matches the resonant frequency of the antenna portion 144 of the tire-based unit 34 and when an impedance of the antenna 104 of the reader portion 60 matches the impedance of the antenna 146 of the antenna portion 144 of the tire-based unit 34.

As is shown in FIG. 3, the antenna portion 144 is operatively coupled to rectifying and regulating circuitry 154. The rectifying and regulating circuitry 154 receives the electric energy from the antenna portion 144, converts the alternating current of the received electrical energy into direct current, and outputs electrical energy having a regulated direct current. The rectifying and regulating circuitry 154 provides the rectified and regulated electrical energy to an energy storage device 160.

The energy storage device 160 may include one or more capacitors for storing the rectified and regulated electrical energy. The energy storage device 160 supplies the electrical energy to power the tire-based unit 34. When the energy storage device 160 includes one or more capacitors, the energy storage device 160 is isolated from the antenna portion 144, preferably, using diodes (not shown), so that the capacitance of the energy storage device 160 does not affect the capacitance value of the antenna portion 144.

The tire-based unit 34 also includes transmit circuitry 164. The transmit circuitry 164 is operatively coupled to the controller 134. The transmit circuitry 164 includes components for communicating message packets that include the sensed tire parameters to the reader portion 60 of the vehicle-based unit 54. For example, when the tire-based unit 34 communicates with the reader portion 60 using backscafter modulation, the transmit circuitry 164 may include a shorting transistor that is applied across the antenna 146 and that has the effect of changing the reflectivity of the antenna. By changing the reflectivity of the antenna 146, a message packet provided by the controller 134 and including the sensed parameters is modulated onto energy that the antenna 146 reflects back toward the reader portion 60. As an alternative to using backscatter modulation, transmit circuitry 164 of the tire-based unit 34 may include a transmitter (not shown) that is operatively coupled to the antenna portion 144 for transmitting parameter signals 44.

In response to the energy storage device 160 of the tire-based unit 34 being charged to a predetermined value, the controller 134 monitors the associated sensors 126, 128, and 130 and assembles a message packet that includes the sensed parameters. The controller 134 outputs the message packet to the transmit circuitry 164 for transmission to the vehicle-based unit in a parameter signal 44. The controller 134 may output the same message packet numerous times to ensure that at least one parameter signal 44 indicating the sensed parameters is received at the vehicle-based unit 54. In one embodiment, the controller 134 outputs each message packet three times at spaced intervals of time. As a result, the tire-based unit 34 transmits three parameter signals 44 indicating the sensed parameters.

When the reader portion 60 of the vehicle-based unit 54 receives a parameter signal 44 from the tire-based unit 34, the received signal is provided to through the receive circuitry 118 of the reader portion 60. The received parameter signal 44 is demodulated and conditioned and the message packet received in the parameter signal 44 is provided to the controller 90 in the central portion 56 of the vehicle-based unit 54. The controller 90 associates the received message packet to the reader portion 60 from which the signal was received. As a result, the controller 90 of the vehicle-based unit 54 may associate the data regarding the sensed parameters of tire 16 with the location on the vehicle of reader portion 60. The controller 90 includes the sensed parameters and the associated tire location in a display signal that is provided to the display 100. The display 100 is responsive to receipt of the display signal for providing an indication of the sensed parameters and the associated tire location.

The vehicle-based unit 54 is configured for maximizing the signal strength of the parameter signals 44 received at the reader portion 60. The vehicle-based unit 54 maximizes the signal strength of the parameter signals 44 by adjusting the tuner 106 for matching the impedance of the antenna 104 of the reader portion 60 to the impedance of the antenna portion 144 of the tire-based unit 34. The vehicle-based unit 54 also maximizes the signal strength by controlling the variable frequency signal generator 112. For example, when the tire-based unit 34 communicates with the reader portion 60 using backscatter modulation, the backscatter power at the reader portion 60 is determined by the following formula:
P_{RPR}=P_{RPE}×((G_{RP(freq)}²×G_{TBU(freq)}×K)÷((4×π×r)÷λ)⁴)
In which P_{RPR} is the power at a particular frequency of the backscattered signal received at the reader portion 60, P_{RPE} is the power at the particular frequency emitted from the reader portion 60, G_{RP} is the gain of the reader portion 60 at the particular frequency, G_{TBU} is the gain at the tire-based unit 34 at the particular frequency, K is dependent upon load switching at the tire-based unit 34, r is the distance between the reader portion 60 and the tire-based unit 34, and λ is the wavelength of the signals. The controller 90 of the vehicle-based unit 54 controls the variable frequency signal generator 112 for providing signals at a frequency for maximizing the gains G_{RP} and G_{TBU} at the reader portion 60 and the tire-based unit 34.

To determine the setting of the tuner 106 and the frequency value for the variable frequency signal generator 112 at which the power of the parameter signals 44 is maximized, the controller 90 of the vehicle-based unit 54 sets the tuner 106 to a first setting. The controller 90 then controls the variable frequency signal generator 112 to provide signals while scanning or sweeping its range of frequencies. While the variable frequency signal generator 112 sweeps its range of frequencies, the controller 90 of the vehicle-based unit 54 monitors the power of the parameter signals 44 being received by the reader portion 60. The controller 90 then sets the tuner 106 to a second setting, and repeats the above process. After the power of the parameter signals 44 has been monitored for the range of frequencies of the variable frequency signal generator 112 at all of the settings of the tuner 106, the controller 90 sets the tuner 106 to the setting at which the power of the parameter signal 44 was maximized and also sets the frequency of the variable frequency signal generator 112 to the value at which the power of the parameter signal was maximized.

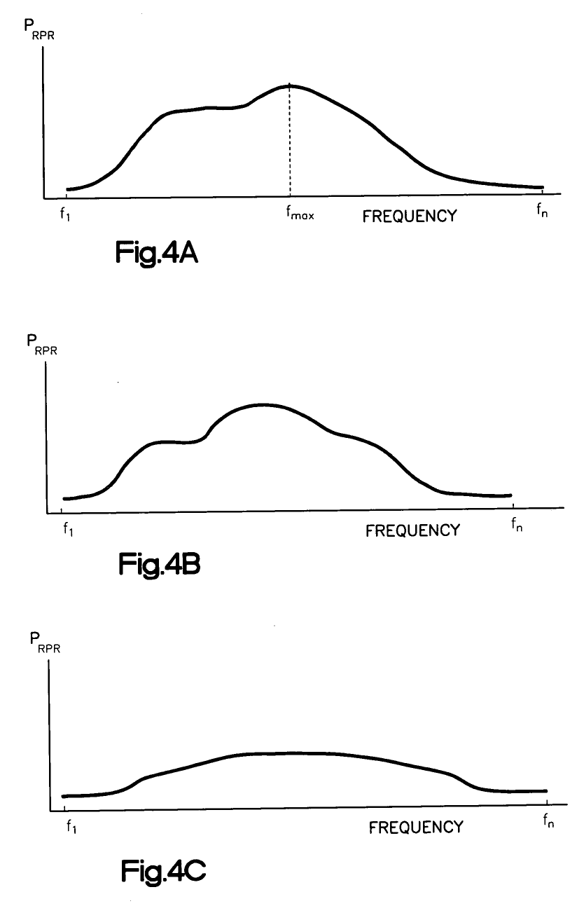

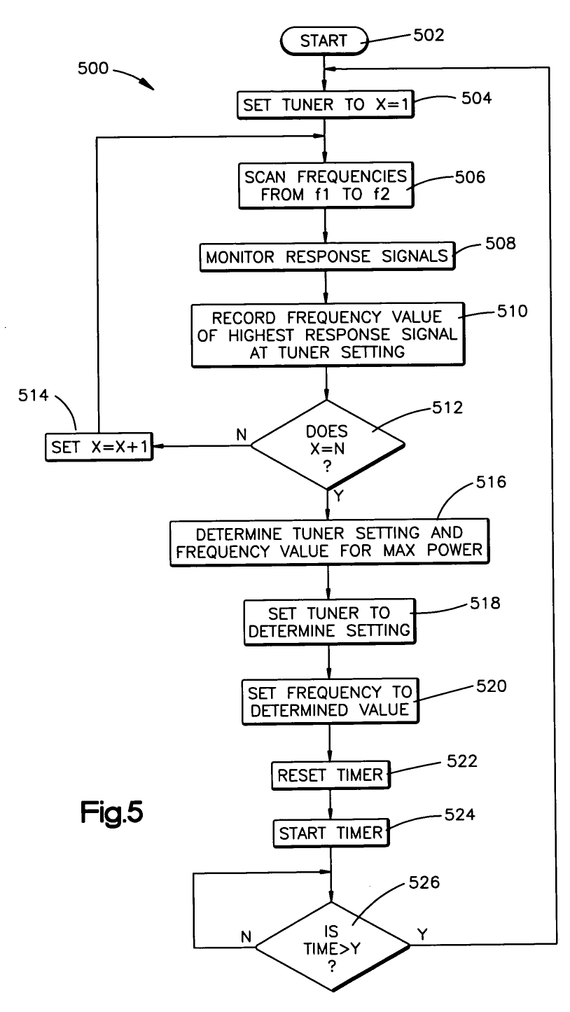

FIGS. 4A-4C are graphs in which the power P_{RPR} of the backscatter signals received at the reader portion 60 is plotted as a function of frequency for various tuner settings of the tuner 106. The graphs also illustrate the frequency range, f₁ to fₙ, of the variable frequency signal generator 112. FIG. 4A illustrates the power P_{RPR} of the backscatter signals received at a first tuner setting. FIG. 4B illustrates the power P_{RPR} of the backscatter signals received at a second tuner setting. FIG. 4C illustrates the power P_{RPR} of the backscatter signals received at a third tuner setting.

As set forth above, the controller 90 of the vehicle-based unit 54 determines the tuner 106 setting and frequency at which the power P_{RPR} of the backscatter signals is maximized. With reference to the FIGS. 4A-4C, the maximum power of a backscatter signal is found at the first setting (FIG. 4A) of the tuner 106 and at a frequency fₘₐₓ. In response to determining the tuner 106 setting and frequency fₘₐₓ of the maximum power P_{RPR}, the controller 90 sets the tuner 106 and the variable frequency signal generator 112 to the appropriate values for receiving signals at the maximum power P_{RPR}.

FIG. 5 is a flow diagram illustrating an exemplary process 500 performed by a vehicle-based unit of the tire parameter sensing system of the present invention. The process 500 illustrated in FIG. 5 is directed to a single reader portion of the tire parameter sensing system. The process 500 may be repeated for each reader portion of the vehicle-based unit 54.

The process 500 begins at step 502 in response to the vehicle-based unit 54 first being powered. At step 504, the tuner of the reader portion is set to a first setting. At step 506, the frequencies of the variable frequency signal generator are scanned or swept. At step 508, the power of response signals, i.e., parameter signals, from the tire-based unit are monitored. At step 510, the frequency value for the highest power response signal at the current tuner setting is recorded. From step 510, the process 500 proceeds to step 512.

At step 512, a determination is made as to whether the frequencies of the variable frequency signal generator have been scanned for each available setting of the tuner. If the determination at step 512 is negative, the process 500 proceeds to step 514 and the tuner of the reader portion is set to the next available setting. From step 514, the process 500 returns to step 506. If the determination at step 514 is affirmative, the process 500 proceeds to step 516.

At step 516, the tuner setting and frequency value for the maximum power response signal is determined. One method of determining the tuner setting and frequency value for the maximum power response signal is to compare the recorded frequency values of step 510 to determine which tuner setting and which frequency value resulted in the highest power response. From step 516, the process 500 proceeds to step 518. At step 518, the tuner is set to the determined setting for maximizing the power of the response signals. At step 520, the frequency of the variable frequency signal generator is set to the determined value for maximizing the power of the response signals.

From step 520, the process 500 proceeds to step 522. At step 522, a timer associated with the controller of the vehicle-based unit is reset. At step 524, the timer is started. At step 526, a determination is made as to whether a predetermined amount of time, indicated as Y, has expired since the timer was started. When the determination at step 526 is negative, the setting of the tuner and the signal frequency output from the variable frequency signal generator remain unchanged. When the determination at step 526 is affirmative, the process 500 returns to step 504 and repeats itself. The predetermined amount of time is an amount of time in which an environmental change may have affected the impedance of the tank circuit of the tire-based unit and tuning of the reader portion is again desired. For example, the predetermined amount of time may be every thirty minutes.

As an alternative to repeating the process 500 in response to the expiration of time, the occurrence of other predefined events may be used for causing to process 500 to repeat itself for readjusting the tuner setting and the frequency value of the variable frequency signal generator for maximizing the signal strength of the parameter signals. For example, the process 500 may repeat itself upon each vehicle start and remain unchanged while a vehicle is operating.

From the above description of the invention, those skilled in the art will perceive improvements, changes and modifications. Such improvements, changes and modifications within the skill of the art are intended to be covered by the appended claims.

Having described the invention, I claim the following:

1. A tire parameter sensing system for sensing a parameter of a tire of a vehicle, the tire parameter sensing system comprising:
a vehicle-based unit for transmitting first signals and for receiving second signals; and
a tire-based unit that is associated with the tire of the vehicle, the tire-based unit being responsive to received first signals for sensing the parameter of the tire and for transmitting second signals indicative of the sensed parameter, an antenna portion of the tire-based unit having an impedance that varies in response to varying environmental conditions,
the vehicle-based unit including a tuner and a controller, the controller monitoring a condition of received second signals at various settings of the tuner and thereafter, setting the tuner for maximizing the condition of the received second signals.

2. The tire parameter sensing system of claim 1 wherein the condition of the received second signal that is maximized is power.

3. The tire parameter sensing system of claim 1 wherein the first signals transfer power from the vehicle-based unit to the tire-based unit, the second signals being backscatter modulated by the tire-based unit, the condition that is maximized being power of the backscattered second signals.

4. The tire parameter sensing system of claim 1 wherein the tuner adjusts the impedance of an antenna of the vehicle-based unit from which the first signals are transmitted and the second signals are received.

5. The tire parameter sensing system of claim 4 wherein the controller controls the tuner to match the impedance of the antenna of the vehicle-based unit to an impedance of the antenna portion of the tire-based unit.

6. The tire parameter sensing system of claim 4 wherein the controller is located in a central portion of the vehicle-based unit and the tuner is located in a reader portion that is spaced away from the central portion.

7. The tire parameter sensing system of claim 1 wherein the vehicle-based unit also includes a variable frequency signal generator for enabling a frequency value of the first signals to be varied within a predefined range.

8. The tire parameter sensing system of claim 7 wherein the controller controls the variable frequency signal generator for setting an output frequency at a frequency value for maximizing the condition of the received second signals.

9. The tire parameter sensing system of claim 8 wherein the condition of the received second signal that is maximized is power.

10. The tire parameter sensing system of claim 9 in which the second signal is backscatter modulated by the tire-based unit, the controller setting the frequency value of the variable frequency signal generator for maximizing gains at the tire-based unit and at a reader portion of the vehicle-based unit.

11. The tire parameter sensing system of claim 1 wherein the controller of the vehicle-based unit is associated with a means for determining an occurrence of a predefined event, the controller being responsive to the occurrence of the predefined event for readjusting the tuner.

12. A method of operating a tire parameter sensing system of a vehicle, the tire parameter sensing system having a vehicle-based unit and a tire-based unit, the tire-based unit being associated with a tire of the vehicle and including an antenna portion having an impedance that varies in response to varying environmental conditions, the method comprising the steps of:
transmitting first signals from the vehicle-based unit;
sensing the parameter of the tire and transmitting second signals in responds to receiving first signals at the tire-based unit;
receiving the transmitted second signal at the vehicle-based unit;
monitoring a condition of second signals received at the vehicle-based unit at various settings of a tuner of the vehicle-based unit; and thereafter
setting the tuner of the vehicle-based unit for maximizing the condition of the received second signals.

13. The method of claim 12 wherein the step of setting the tuner of the vehicle-based unit for maximizing the condition of the received second signals includes the step of setting the tuner for maximizing power of the received second signals.

14. The method of claim 13 further including the steps of transferring power from the vehicle-based unit to the tire-based unit in the first signals, transmitting the second signals from the tire-based unit by backscatter modulation.

15. The method of claim 12 wherein the step of setting the tuner of the vehicle-based unit for maximizing the condition of the received second signals includes the step of adjusting, with the tuner, the impedance of an antenna of the vehicle-based unit from which the first signals are transmitted and the second signals are received.

16. The method of claim 15 further including the step of matching the impedance of the antenna of the vehicle-based unit to an impedance of the antenna portion of the tire-based unit.

17. The method of claim 12 further including the steps of sweeping a frequency range while transmitting the first signals, determining a frequency value at which the condition of the received second signals is maximized, and thereafter, setting an output frequency of a variable frequency signal generator of the vehicle-based unit at the frequency value at which the condition of the received second signals is maximized.

18. The method of claim 17 further including the step of transmitting the second signals from the tire-based unit by backscatter modulation, the step of setting an output frequency of a variable frequency signal generator at the frequency value at which the condition of the received second signals is maximized further including the step of setting the output frequency of the variable frequency signal generator at a frequency value for maximizing gains at the tire-based unit and at a reader portion of the vehicle-based unit.

19. The method of claim 12 further including the steps of sensing for an occurrence of a predefined event, and repeating the method in response to the occurrence of the predefined event.

20. The method of claim 19 wherein the step of sensing for an occurrence of a predefined event further includes the steps of starting a timer, monitoring an amount of time that has elapsed since the timer was started, and comparing the amount of elapsed time to a predetermined threshold.
